(19) United States
(12) Patent Application Publication
(10) Pub. No.: US 2011/0035409 A1
(43) Pub. Date: Feb. 10, 2011

(54) HIERARCHICAL STORAGE SYSTEM AND COPY CONTROL METHOD OF FILE FOR HIERARCHICAL STORAGE SYSTEM

(75) Inventors: Akio SHIMADA, Yokohama (JP); Etsutaro Akagawa, Kawasaki (JP); Hitoshi Kamei, Sagamihara (JP); Nobumitsu Takaoka, Sagamihara (JP); Atsushi Sutoh, Yokohama (JP); Masakuni Agetsuma, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/575,138

(22) Filed: Oct. 7, 2009

(30) Foreign Application Priority Data
Aug. 6, 2009 (JP) 2009-182991

(51) Int. Cl. G06F 17/30; G06F 12/00

(52) U.S. Cl. 707/783; 707/E17.01; 707/E17.032; 707/829

(57) ABSTRACT

An interface for controlling an inhibition of a recall is prepared for an application, and a judgment of necessity of a recall is informed of to a hierarchical storage before the application executes an access to a file.

### CROSS-REFERENCE TO PRIOR APPLICATION

This application relates to and claims the benefit of priority from Japanese Patent Application number 2009-182991, filed on Aug. 6, 2009 the entire disclosure of which is incorporated herein by reference.

### BACKGROUND

The present invention generally relates to a system and a method for controlling a recall of a file between storage devices for a hierarchical storage device, which is utilized by an application.

The hierarchical storage management technology (HSM) has been proposed as the technology for building a large-capacity and high-speed storage device at a low cost. For the HSM, a hierarchization of a primary storage that can access a stored file at a high speed and that has a small capacity and a secondary storage that accesses a stored file at a low speed and that has a large capacity is executed to form one storage device. A file that is frequently referred to is stored into the primary storage and data that is less referred to is stored into the secondary storage, thereby implementing a large-capacity and high-speed storage device at a low cost. A client that utilizes a file server can transparently access a file that has been stored into a storage device of each hierarchy.

The Patent Citation 1 (U.S. Pat. No. 7,225,211) discloses the technology in which a hierarchization of a plurality of storage devices that are provided with different features is executed to form one storage device.

### SUMMARY

In the conventional art, in the case in which a client that utilizes a file server does not access a file that has been stored into a primary storage for a certain period of time, the file is migrated to a secondary storage. In the case in which a file that has been migrated to a secondary storage is accessed, it is highly possible that the file is accessed afterward more than once. Consequently, the HSM copies the file back to a primary storage that can be accessed at a high speed (hereafter referred to as a recall). As described above, a file that has not been accessed for a while from a client is migrated to a secondary storage, and is recalled to a high-speed primary storage in the next access, thereby implementing a high-speed access to a file and a large amount of capacity at a low cost.

However, for the conventional hierarchical storage, in the case in which a file that has been migrated to a secondary storage is accessed, it is not suitable in some cases that all files that have been accessed are recalled. In the case in which all files that have been accessed are recalled, a file that has a low possibility of being accessed again is stored into a primary storage that has a limited capacity in some cases. In addition, a copy of a file that is not required to be recalled to a primary storage is generated, thereby deteriorating a performance of a storage device.

An object of the present invention is to provide an interface for inhibiting a recall of a file by an application on a client that utilizes a hierarchical storage. In other words, a means for informing a hierarchical storage that a recall of a file is not necessary is provided to an application. The information from the application is then received, and a function for inhibiting a recall of a file is provided to the hierarchical storage.

In the case in which an application that utilizes a hierarchical storage accesses a file, the application informs the hierarchical storage that the recall of a file is inhibited.

By the present invention, in the case in which an application that utilizes a hierarchical storage accesses a file that has been stored into a secondary storage, a recall of a file can be inhibited. As a result, an unnecessary copy of a file can be prevented and a file that has a low possibility of being accessed again can be prevented from being stored into a primary storage.

### BRIEF DESCRIPTION OF THE DRAWINGS

FIG. 1 is a view showing a summary in accordance with the present invention.

FIG. 2 is a view showing a hardware configuration in accordance with an embodiment of the present invention.

FIG. 3 is a view showing a software configuration of a primary file storage.

FIG. 4 is a view showing a software configuration of a secondary file storage.

FIG. 5 is a view showing a software configuration of a client.

FIG. 6 is a view showing a configuration of inode and a storage area of inode.

FIG. 7 is a view showing a stub and a normal file.

FIG. 8 is a view showing a configuration of a directory file.

FIG. 9 is a flowchart showing a file migration processing.

FIG. 10 is a view showing a processing summary in the case in which an application executes a normal file operation to a file on a primary file server.

FIG. 11 is a view showing a processing summary in the case in which an application executes a recall control to a file on a primary file server.

FIG. 12 is a view showing a structure of a recall inhibiting list.

FIG. 13 is a flowchart showing a registration processing to a recall inhibiting list.

FIG. 14 is a flowchart showing a recall processing.

FIG. 15 is a flowchart showing a read/write processing to a file.

FIG. 16 is a view showing an example of a reporting log.

FIG. 17 is a GUI drawing that presents the reporting information to an administrator.

FIG. 18 is a GUI drawing for selecting a file that indicates the reporting information.

### DETAILED DESCRIPTION OF THE EMBODIMENT

A mode for the present invention will be described below in detail.

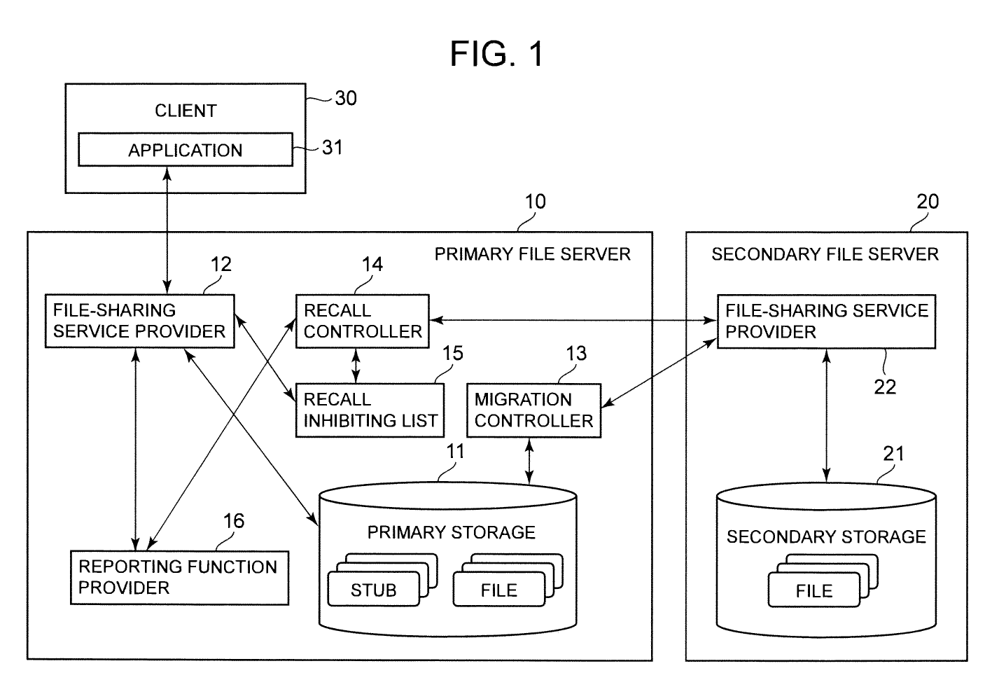

FIG. 1 is a schematic view for illustrating a summary of a hierarchical storage in accordance with the present invention.

A primary file server 10 is linked with a secondary file server 20 to build a hierarchical storage. A primary storage 11 that is included in the primary file server 10 stores a file that is frequently accessed by an application 31 on a client 30. A secondary storage 21 that is included in the secondary file server 20 stores a file that is not accessed for a certain period of time by the application 31. The file server 10 and the file server 20 execute a migration and a recall of a file by using a file-sharing service 22.

A migration controller 13 controls a migration of a file that has been stored into the primary storage 11. The migration controller 13 periodically monitors a last access time of a file that has been stored into the primary storage 11. The migration controller 13 compares a current time and a last access time of a file. In the case in which the file is not accessed for a certain period of time, the file is copied to the secondary storage 21 by using the file-sharing service 22 that is provided by the file server 20. The migration controller 13 deletes the file from the primary storage 11 after the migration is completed. The migration controller 13 creates a stub that is corresponded to the file in order to provide a means for accessing the file that has been migrated to the secondary storage 21 by the application 31 on the client 30. The stub is a special file that is provided with the information for accessing the file that has been migrated to the secondary storage 21 by the application 31. The stub records a path on the secondary file server 20 for the file that has been migrated. Afterward, the application 31 recognizes the stub as the file that has been migrated to the secondary storage 21. A sequence of processing described above is defined as a migration processing.

A recall controller 14 controls a recall of a file. In the case in which the stub that has been stored into the primary storage 11 is accessed from the application 31, the recall controller 14 recalls the corresponding file from the secondary storage 21 via a file-sharing service 12. In a recall, a stored location of a file on the secondary file server 20 is recognized by using a path that has been recorded in the stub. In the case in which the information for inhibiting a recall of a file is received from the application 31, the recall controller 14 does not execute a recall of the file. Whether or not the information is received from the application 31 is judged by referring to a recall inhibiting list 15.

The file-sharing service 12 processes an operation from the application 31 such as the read/write, the creation/deletion, and the modification/confirmation of an attribute for a file on the primary storage. In addition, the file-sharing service 12 receives a recall inhibiting instruction from the application 31, and updates the recall inhibiting list.

A reporting controller 16 records an access time to a file, an inhibiting start time of a recall, and an inhibiting release time of a recall as a log for each client. The reporting controller 16 then processes the log as the reporting information, and presents the reporting information to an administrator. Moreover, the reporting controller 16 executes a forced release of a recall inhibition based on a log.

In FIG. 1, one client is coupled to the primary file server. However, a plurality of clients can also be coupled to the primary file server.

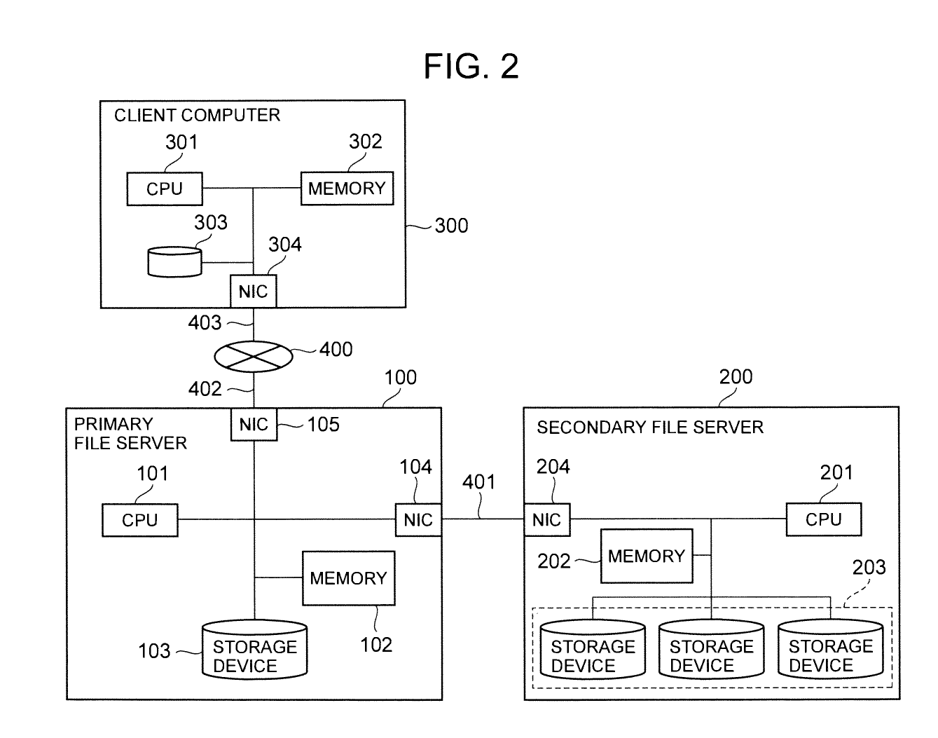

FIG. 2 is a view showing a hardware configuration of a hierarchical storage in accordance with the present invention.

A primary file server 100 is configured by a CPU (Central Processing Unit) 101, a memory 102, a storage device 103, and NICs (Network Interface Cards) 104 and 105. Each configuration element is coupled to each other via an internal bus or an internal network. The numbers of CPUs, memories, NICs, and storage devices are not restricted to the numbers indicated in the figure. The primary file server 10 is provided with a screen display device. The reporting information that is described later and so on are displayed on the screen display device.

The CPU 101 executes a program that has been stored into the memory 102. For instance, the CPU 101 executes a program that provides a file-sharing service, and provides a file that has been stored into the storage device 103 to a client computer 300. Hereafter, in the case in which it is described that a program executes a processing, it means that the CPU 101 executes the program in a practical sense.

The memory 102 is a semiconductor memory for instance, and is a main storage device that stores a program that is executed by the CPU 101 and data that is referred to by a program.

The NIC 104 is used for the primary file server 100 to receive data from the secondary file server 200 and to send data to the secondary file server 200. Moreover, the NIC 105 is used for the primary file server 100 to receive data from the client computer 300 and to send data to the client computer 300 via a LAN (Local Area Network) 400.

The storage device 103 is a secondary storage device for storing a program and a file that are used by the primary file server 100. For the primary file server, an SSD (Solid State Drive), an HDD (Hard Disk Drive), a tape device or the like can be used as a secondary storage device. The storage device 103 is coupled to other configuration elements via an internal bus in the figure. However, the storage device 103 can also be coupled to other configuration elements via a storage controller such as a RAID (Redundant Array of Independent Disks) controller. Moreover, the storage device 103 on a SAN (Storage Area Network) can also be coupled to other configuration elements via an FC (Fiber Channel) HBA (Host Bus Adaptor).

A secondary file server 100 is configured by a CPU 201, a memory 202, a storage device 203, and a NIC 204. Each configuration element is coupled to each other via an internal bus or an internal network. The numbers of CPUs, memories, storage devices, and NICs are not restricted to the numbers indicated in the figure.

The CPU 201 executes a program that has been stored into the memory 202. For instance, the CPU 201 executes a program that provides a file-sharing service, and provides a file that has been stored into the storage device 203 to the primary file server 100.

The memory 202 is a semiconductor memory for instance, and is a main storage device that stores a program that is executed by the CPU 201 and data that is referred to by a program.

The NIC 204 is used for the secondary file server 200 to receive data from the primary file server 100 and to send data to the primary file server 100.

The storage device 203 is a secondary storage device for storing a program and a file that are used by the secondary file server 200. For the secondary file server, an SSD, an HDD, a tape device or the like can be used as a secondary storage device. The storage device 203 is coupled to other configuration elements via an internal bus in the figure. However, the storage device 203 can also be coupled to other configuration elements via a storage controller such as a RAID controller. Moreover, the storage device 203 on a SAN can also be coupled to other configuration elements via an FC HBA.

To build a hierarchical storage, devices that have different features are used as the storage device 103 of the primary file server 100 and the storage device 203 of the secondary file server 200. For instance, an SSD in which a high speed read/write of data is enabled and in which a unit price per bit is high is used for the storage device 103, an HDD or a tape device in which a unit price per bit is low and in which a read/write performance is low is used for the storage device 203. Moreover, a larger capacity device is used for the storage device 203 as compared with the storage device 103, or a plurality of devices are used for forming one storage device, whereby a file storage area of the storage device 203 can be larger than that of the storage device 103.

A client computer 300 is configured by a CPU 301, a memory 302, a storage device 303, and a NIC 304. Each configuration element is coupled to each other via an internal bus or an internal network. The numbers of CPUs, memories, storage devices, and NICs are not restricted to the numbers indicated in the figure.

The CPU 301 executes a program that has been stored into the memory 302. For instance, the CPU 301 executes a program that provides a file-sharing service, and accesses a file that has been stored into the storage device 103 of the primary file server 100.

The memory 302 is a semiconductor memory for instance, and is a main storage device that stores a program that is executed by the CPU 301 and data that is referred to by a program.

The NIC 304 is used for the client computer 300 to receive data from the primary file server 100 and to send data to the primary file server 100 via the LAN 400.

The storage device 303 is a secondary storage device for storing a program and a file that are used by the client computer 300. For the client computer, an SSD, an HDD, a tape device or the like can be used as a secondary storage device. The storage device 303 is coupled to other configuration elements via an internal bus in the figure. However, the storage device 303 can also be coupled to other configuration elements via a storage controller such as a RAID controller. Moreover, the storage device 303 on a SAN can also be coupled to other configuration elements via an FC HBA.

It can be thought that the Ethernet (registered trademark) is used as a communication path 401 between the NIC 104 and the NIC 204 for instance. Providing a communication is possible, other media can also be used.

It can be thought that the Ethernet (registered trademark) is used as a communication path 402 between the NIC 105 and the LAN 400 for instance. Providing a communication is possible, other media can also be used.

It can be thought that the Ethernet (registered trademark) is used as a communication path 403 between the NIC 304 and the LAN 400 for instance. Providing a communication is possible, other media can also be used.

One client is set in the figure. However, this does not restrict that a plurality of clients are coupled to the primary file server.

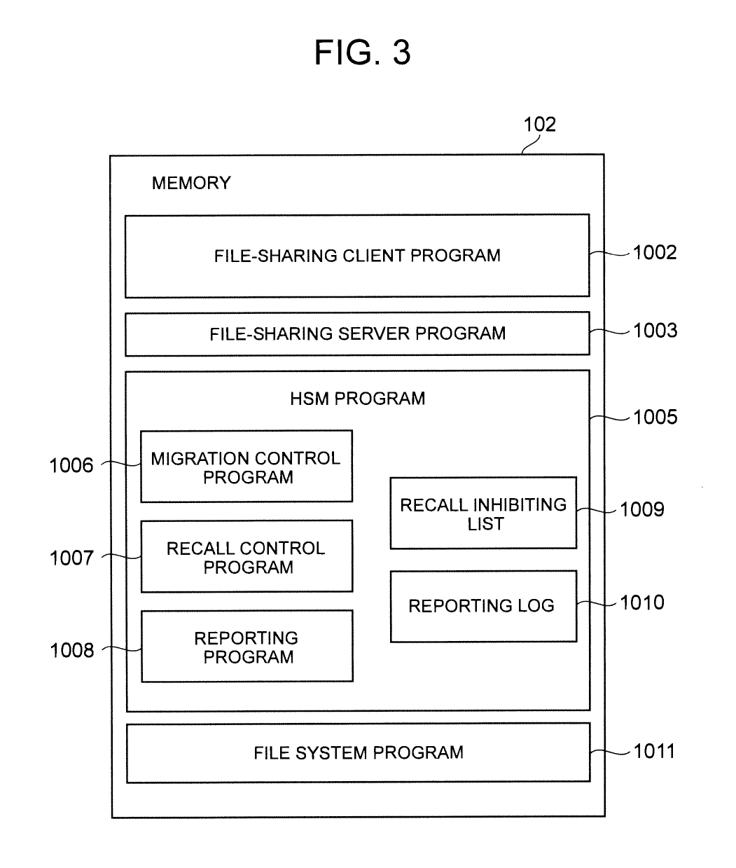

FIG. 3 is a view showing a configuration of a program that has been stored into the memory 102 of the primary file server 100 and data that is referred to by the program.

A file-sharing client program 1002 is a program that is used for executing a file operation to a file on the secondary file server 200 that is executing a file-sharing server program 2001 by the primary file server 100. The file operation is a read/write processing, the confirmation/modification of an attribute of a file or the like.

A file-sharing server program 1003 is a program for providing a means for executing a file operation to a file on the primary file server 100 by the client 300. In addition, the file-sharing server program 1003 processes a recall control operation that is executed to a file on the primary file server 100 by an application 3001 on the client computer 300.

In general, a file-sharing program is classified into a client program and a server program. A local server that is executing a client program can handle a file system on a remote server that is executing a server program as a file system on a local server that is executing a client program. More specifically, a local server that is executing a client program can execute a file operation such as the read/write, the creation/deletion, and the confirmation/modification of an attribute for a file to a file system of a remote server that is executing a server program.

In a mode in accordance with the present invention, an NFS (Network File System) and a CIFS (Common Internet File System) are assumed as a file-sharing program.

An HSM program 1005 is a program that runs on the primary file server 100 to build a hierarchical file storage. The HSM program 1005 includes a migration control program 1006 for controlling a migration of a file, a recall control program 1007 for controlling a recall of a file, and a reporting program 1008 for presenting the reporting information such as an access time to a file that has been stored into the storage device 103 and a recall inhibiting start time of a file to an administrator of a hierarchical storage. In addition, the HSM program 1005 includes a recall inhibiting list 1009 that is referred to by the recall control program 1007 and a reporting log area 1010 that is referred to by the reporting program 1008.

The migration control program 1006 retrieves a file to which a migration is to be executed from the storage device 103, and migrates the file to the storage device 203 on the secondary file server 200.

The recall control program 1007 controls a recall of a file. In the case in which a file that has been stored into the storage device 103 is accessed from an application 3001 on the client computer 300, the recall control program 1007 recalls the file from the secondary file server 200. In the recall, the recall control program 1007 refers to the recall inhibiting list 1009. In the case in which a recall to a file to which a recall is to be executed is inhibited, a recall of the file is not executed.

The reporting program 1008 processes the information of the reporting log 1010 and displays the reporting information to an administrator of a hierarchical storage. The reporting log 1010 records an access time to a file, a recall inhibiting start time to a file, and a recall inhibiting release time. Moreover, the reporting program 1008 executes a forced release of a recall inhibition based on a reporting log.

A file system program 1011 is a program for processing an operation (such as the read/write, the creation/deletion, and the modification/confirmation of an attribute) that is executed to a file that has been stored into the storage device 103 by the file-sharing server program 1003 and the HSM program 1005.

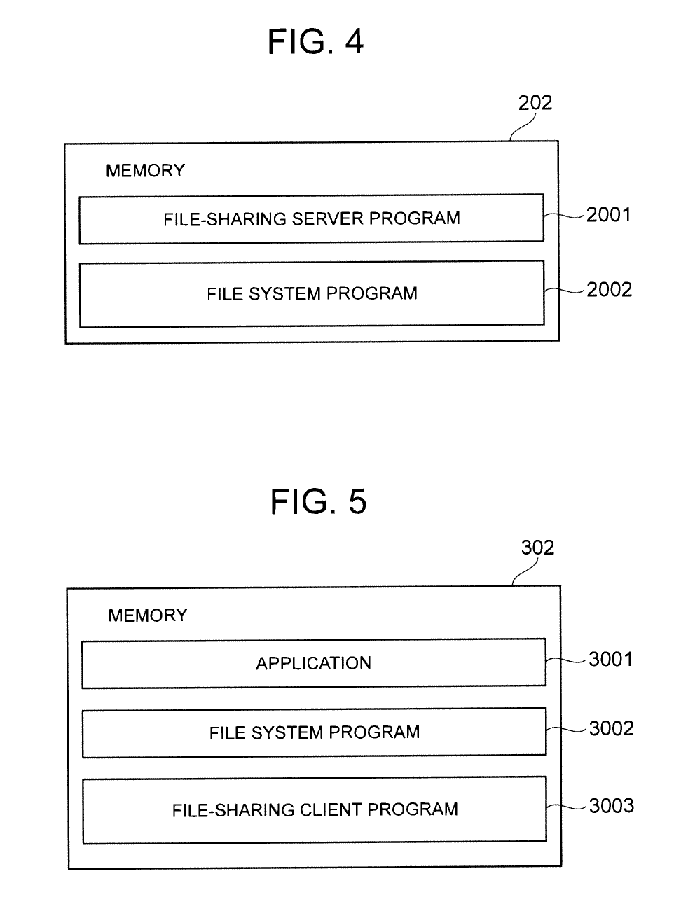

FIG. 4 is a view showing a configuration of a program that has been stored into the memory 202 of a secondary file server 200.

A file-sharing server program 2001 is a program for providing a means for executing a file operation to a file on the secondary file server 200 by the primary file server 100 that is executing the file-sharing client program 1002.

A file system program 2002 is a program for processing an operation (such as the read/write, the creation/deletion, and the modification/confirmation of an attribute) that is executed to a file that has been stored into the storage device 103 by the file-sharing server program 2001.

FIG. 5 is a view showing a configuration of a program that has been stored into the memory 302 of a client 300.

An application 3001 is a business application that accesses a file on the primary file server 100. For instance, the application 3001 is the antivirus software that executes a virus detection of a file that has been stored into the hierarchical storage or the backup software that executes a backup of a file that has been stored into the hierarchical storage.

A file system program 3002 directs a file-sharing client program 3003 to transmit a file operation request (such as the read/write, the creation/deletion, and the modification/confirmation of an attribute) for the primary file server 100 from the application 3001 to the primary file server 100.

The file-sharing client program 3003 transmits an operation that has been requested to the file system program 3002 by the application 3001 to the file-sharing server program 1003. By using the file-sharing client program 3003, the client 300 executes a file operation to a file on the primary file server 100.

A method for managing a file that has been stored into the storage device 103 by the file system program 1011 will described in the following.

The file system program 1011 manages the data and attribute of a file by inode. One inode exists for each file, and the inode stores the metadata of the file.

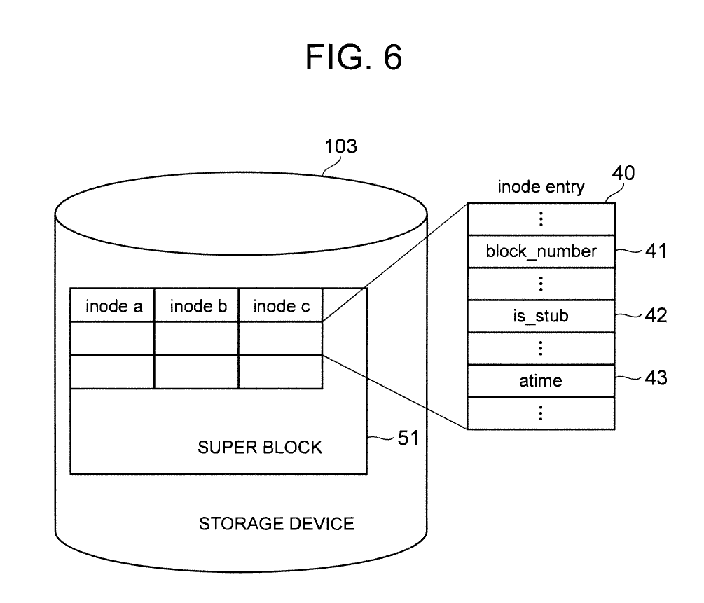

FIG. 6 is a view showing a configuration of Mode and a storage area of Mode. A block_number entry 41 of an Mode structure 40 stores a block number of a block that stores the data of a file. An is_stub entry 42 is a flag that indicates whether or not the file is a stub. An atime entry 43 stores a last access time to a file. In addition, there are other entries that store an access permission and a last update time of a file in Mode. The Mode is stored into a special area (super block 51) of the storage device 103. The file system program 1011 can acquire the attribute of each file and a storage location on the storage device 103 by referring to mode.

In the case in which the file is a stub, a block that is indicated by the block_number entry 41 stores a path on the secondary file server for a file that is corresponded to the stub.

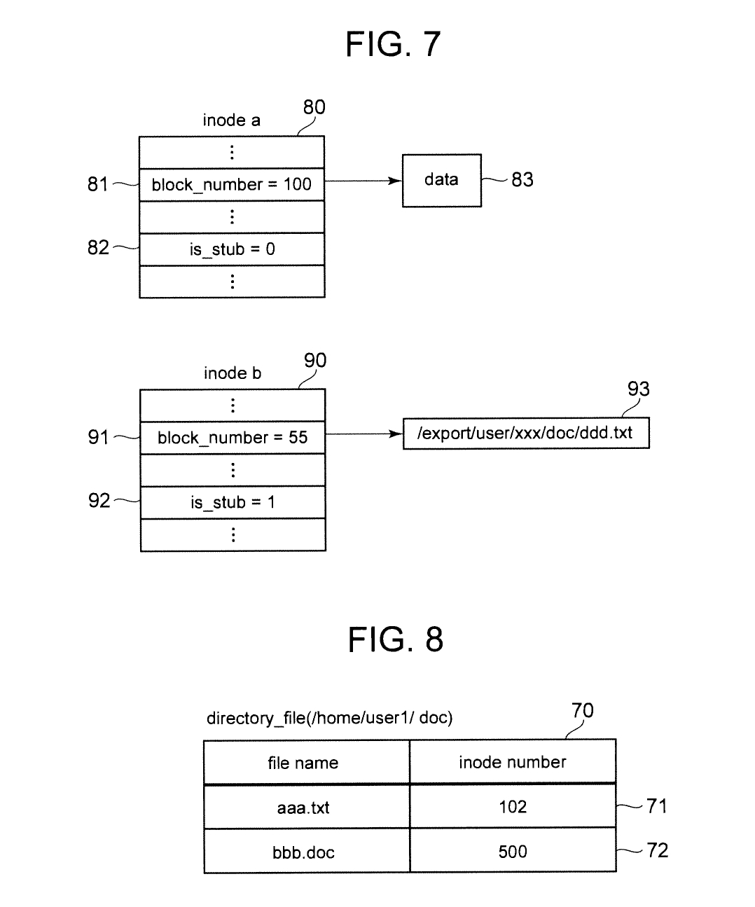

FIG. 7 illustrates that the information that is stored into Mode is different depending on whether or not the file is a stub. Here, a file includes a file that is provided with the data of a stub and an entity. For an mode a (structure 80), a value of an is_stub entry 82 is 0 (that is, a file is not a stub). In this case, a block 83 (block number 100) that is indicated by a block_number entry 81 stores the data of a file. On the other hand, for an inode b (structure 90), a value of an is_stub entry 92 is 1 (that is, a file is a stub). In this case, a block 93 (block number 55) that is indicated by a block_number entry 91 stores the information of a path on the secondary file server for a file that is corresponded to the stub.

The location on the storage device of inode that is corresponded to each file can be calculated by an inode number that is assigned to each inode. The inode number that is corresponded to each file is stored into a special file that is called a directory file. One directory file exists for one directory of a file system.

FIG. 8 is a view showing an example of a directory file. A directory file 70 is a directory file of a /home/user1/doc directory. The /home/user1/doc directory stores the files of aaa.txt and bbb.doc. It can be known from entries 71 and 72 that 102 and 500 are assigned to each of the files, respectively, as an inode number.

The file system program 1011 can know an inode number that is corresponded to a file to which a retrieval is to be executed by tracing a directory that stores a file to which a retrieval is to be executed from a directory file of a root directory. The directory file of a root directory is recorded at the prescribed position of the storage device 103.

The file-sharing server program 1003 and the HSM program 1005 can execute a file operation (such as the read/write, the creation/deletion, and the modification/confirmation of an attribute) to a file that has been stored into the storage device 103 by the file system program 1011.

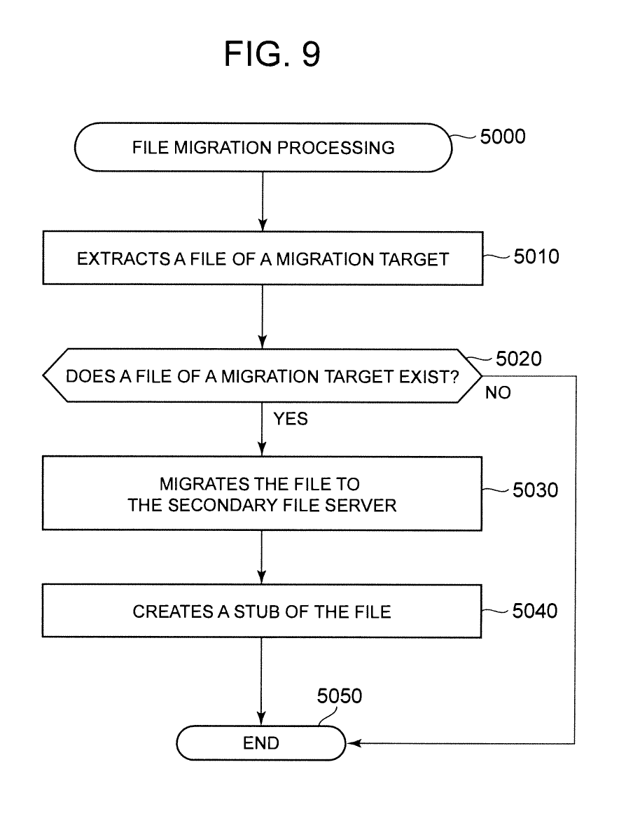

FIG. 9 is a flowchart showing a migration processing of a file by a migration control program 1006.

As described above, a migration processing of a file is executed by the migration control program 1006. The migration control program 1006 periodically retrieves a file that has been stored into the storage device 103 of the primary file server 100, and extracts a file to which a migration is to be executed. When the migration control program extracts a file to which a migration is to be executed, it utilizes the file system program 1011 to confirm an attribute of a file. An attribute of a file is a last access time for instance.

The migration control program 1006 utilizes the file system program 1011 to acquire a last access time (atime) of each file that has been stored into the storage device 103. The migration control program 1006 compares a current time and a last access time. In the case in which the file is not accessed for a certain period of time, the file is migrated to the storage device 203 of the secondary file server 200. The migration of a file is executed by the file-sharing client program 1002.

In a step 5010, the migration control program 1006 utilizes the file system program 1011 to confirm a last access time of a file that has been stored into the storage device 103, and extracts a file to which a migration is to be executed. At this time, the migration control program 1006 can confirm a last access time of all files, or can confirm a last access time of a file that is specified by an administrator of the primary file server 100. For an extraction of a file to which a migration is to be executed, the attribute information other than a last access time can also be utilized.

In the case in which a file to which a migration is to be executed does not exist (step 5020: NO), the migration control program 1006 terminates a file migration processing.

In the case in which a file to which a migration is to be executed exists (step 5020: YES), the migration control program 1006 utilizes the file-sharing client program 1002 to migrate the file to the storage device 203 of the secondary file server (step 5030). After a migration of a file is executed, the migration control program 1006 directs the file system program 1011 to execute a creation of a stub of the file in a step 5040. More specifically, the file system program 1011 sets a value of an is_stub entry of inode of the file to 1, and records a path on the secondary file server of a file that is corresponded to a stub. After that, the migration control program 1006 terminates a file migration processing.

An application 3001 executes a file operation processing to a file on the primary file server. There are two kinds of file operation processing. One is a normal file operation (such as the read/write, the creation/deletion, and the modification/confirmation of an attribute), and the other is a processing for controlling a recall of a file.

An example in which an application executes a control processing of a recall will be described in the following.

There can be mentioned for instance the case in which an application is the antivirus software and scanning of all files is executed. At this time, before an application scans a file, the application starts the inhibition of a recall for a file to which a scan is to be executed. After the scan is completed, the inhibition of a recall for a file is released.

In addition, there can be mentioned for instance the case in which an application starts the inhibition of a recall before accessing a file having a large size, and releases the inhibition of a recall after the access is completed.

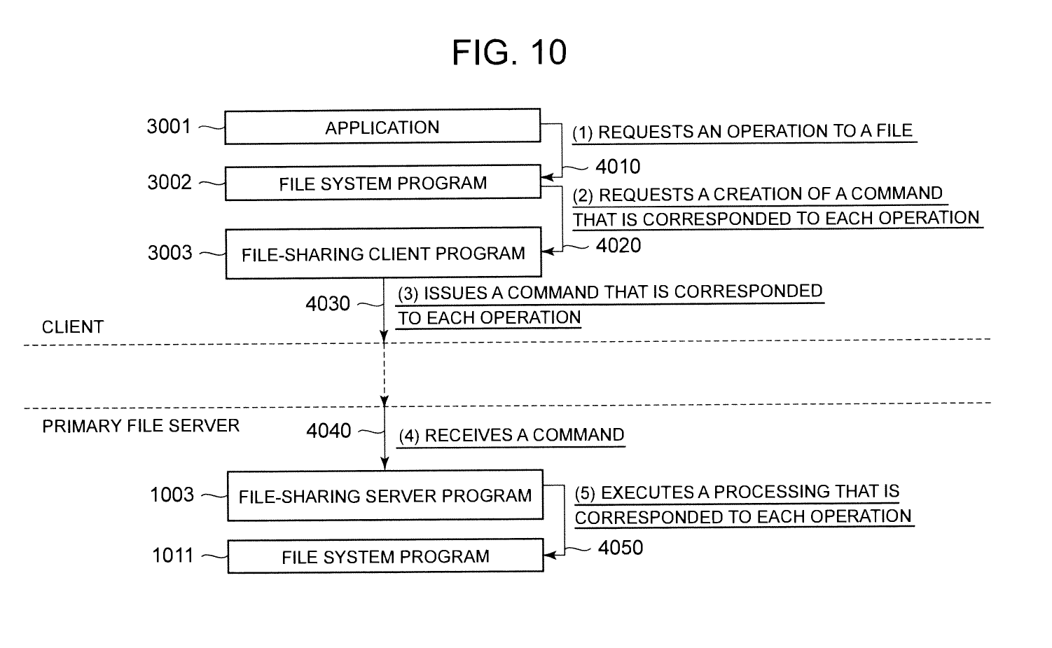

FIG. 10 is a view showing a processing summary in the case in which an application 3001 executes a normal file operation to a file on the primary file server 100.

At first, an application 3001 requests a file operation such as the read/write, the creation/deletion, and the confirmation/modification of an attribute for a file to a file system program 3002 (operation 4010). In the case in which the file is a file on a remote server (the primary file server 100), the file system program 3002 requests an issue of a command to the file-sharing client program 3003 (operation 4020). The file-sharing client converts the processing (the read/write, the creation/deletion, and the confirmation/modification of an attribute for a file) that is requested from the application into a command, and transmits the command to the file-sharing server program 1003 (operation 4030). The file-sharing server program 1003 receives the command that has been transmitted by the file-sharing client program 3003 (operation 4040), and requests a file operation that is corresponded to the command to the file system program 1011 (operation 4050). After that, the file system program 1011 responds the processing result to the client 300. More specifically, the file system program 1011 responds the processing result to the file-sharing server program 1003. The file-sharing server program 1003 then transmits the processing result to the file-sharing client program 3003. The file-sharing client program 3003 then responds the processing result to the file system program 3002. After that, the application 3001 receives the processing result to the file operation.

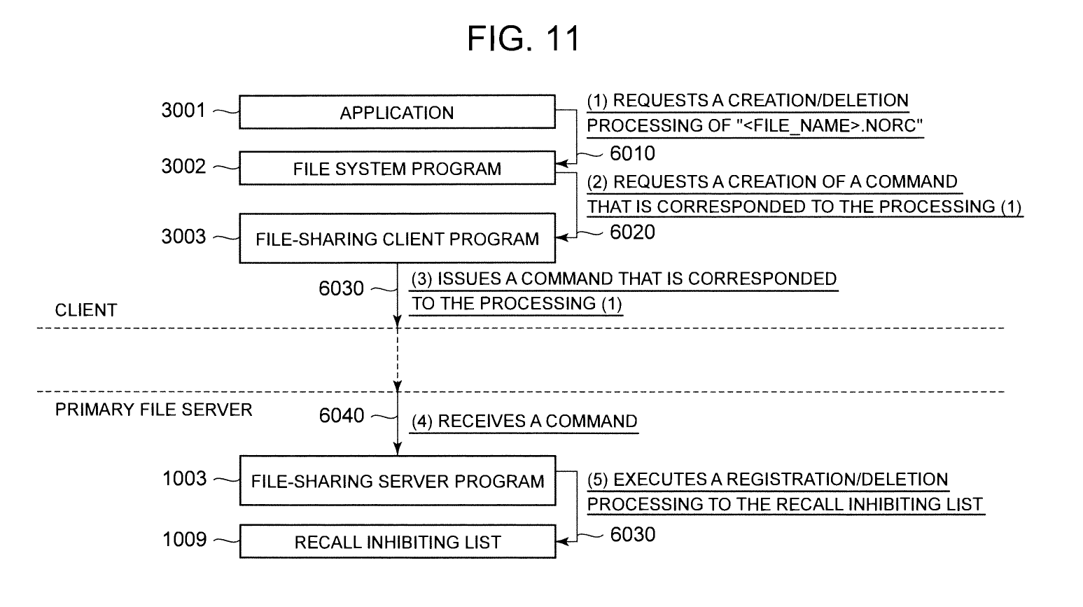

FIG. 11 is a view showing a processing summary in the case in which an application 3001 executes a recall control processing to a file on a primary file server 100 in a mode in accordance with the present invention.

At first, a summary of a recall control processing will be described.

In a mode in accordance with the present invention, similarly to a normal file operation, a protocol of an existing file-sharing program (NFS and CIFS programs) is utilized, and the application 3001 executes a control processing of a recall to a file on the primary file server 100.

An embodiment of a recall control system related to a mode in accordance with the present invention will be described in the following.

In the case in which a recall inhibition of a file is required to be started, the application 3001 requests a creation of a file having a file (path) name of “<file_name>.norc” to the file system program 3002. The “<file_name>” is a file (path) name of a file in which an inhibition of a recall is required. For instance, a recall of /tmp/bbb.doc is required to be inhibited, the application 3001 requests a creation of a file having a name of /tmp/bbb.doc.norc to the file system program 3002. The file system program 3002 requests a creation of a command to the file-sharing client program 3003. The file-sharing client program 3003 creates a command for requesting a creation of /tmp/bbb.doc.norc, and transmits the command to the file-sharing server program 1003. The file-sharing server program 1003 that has received the command for requesting a creation of /tmp/bbb.doc.norc interprets the command as a message for informing of a recall inhibition start of /tmp/bbb.doc, and executes a registration processing to a recall inhibiting list 1009. The file-sharing server program 1003 does not execute a creation of /tmp/bbb.doc.norc in a practical sense.

In the case in which a recall inhibition of a file is required to be released, the application 3001 requests a deletion of a file having a name of “<file_name>.norc” to the file system program 3002. The “<file_name>” is a file (path) name of a file in which an inhibition of a recall is required to be released. For instance, a recall inhibition of /tmp/bbb.doc is required to be released, the application 3001 requests a deletion of a file having a name of /tmp/bbb.doc.norc to the file system program 3002. The file system program 3002 requests a creation of a command to the file-sharing client program 3003. The file-sharing client program 3003 creates a command for requesting a deletion of /tmp/bbb.doc.norc, and transmits the command to the file-sharing server program 1003. The file-sharing server 3003 that has received the command for requesting a deletion of /tmp/bbb.doc.norc interprets the command as a message for informing of a recall inhibition release of /tmp/bbb.doc, and executes a deleting processing from a recall inhibiting list 1009.

A flowchart of the recall control processing will be described in the following. The application 3001 requests an execution of the recall control processing to the file system program 3002 (step 6010). In the above embodiment, a request of a creation processing or a deletion processing of a “<file_name>.norc” file is a processing for controlling a recall.

The file system program 3002 requests an issue of a command to the file-sharing client program 3003 (operation 6020). The file-sharing client converts the processing (the creation/deletion of “<file_name>.norc”) that is requested from the application into a command, and transmits the command to the file-sharing server program 1003 (operation 6030). The file-sharing server program 1003 receives the command that has been transmitted by the file-sharing client program 3003 (operation 6040), and executes the registration/deletion processing to the recall inhibiting list 1009 (operation 6050).

In the above embodiment, the creation/deletion of “<file_name>.norc” is set to a recall control processing. However, other specific processing can also be a recall control processing. The other specific processing will be described in the second and third embodiments.

In the case in which the client computer is coupled to a file server other than a hierarchical storage that is indicated in the mode of the present invention, it is necessary that the application does not execute a recall inhibiting control processing. This is because, in the above embodiment, in the case in which the application 3001 is coupled to a file server other than a hierarchical storage that is indicated in the mode of the present invention and the application 3001 executes a recall control processing, a file having a file (path) name of “<file_name>.norc” is created on the file server. The recall control processing can be prevented from being executed by the following method.

In the mode of the present invention, an administrator of a hierarchical storage can specify whether or not a recall control is to be executed to a file by the application 3001. Before the application 3001 executes a recall control of a file, the application 3001 confirms whether or not a file having a file name of “.recall_control” exists in a directory that has stored the file. In the case in which the file having a file name of “.recall_control” exists, the application 3001 judges that a recall control is to be executed to the file, and executes a recall control processing. In the case in which the file having a file name of “.recall_control” does not exist, the application 3001 judges that a recall control is not to be executed to the file, and interrupts a recall control processing. In the case in which a directory is created in the hierarchical storage of the mode of the present invention, the “.recall_control” file is automatically created. When it is required that a recall control is not to be executed to the file, the administrator deletes the file. Moreover, this function prevents that the application 3001 executes the recall control processing to a file server other than a hierarchical storage in the mode of the present invention. By using this function, providing a user or an administrator does not create a file having a file name of “.recall_control”, the application 3001 does not execute the recall control processing to a file server other than a hierarchical storage indicated by the mode of the present invention.

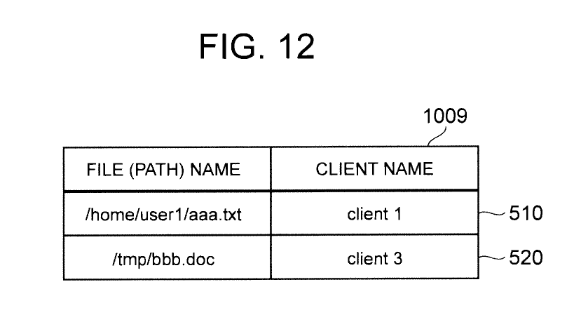

FIG. 12 is a view showing a summary of the recall inhibiting list 1009. As described above, the file-sharing server program 1003 that has received the command of the recall control processing executes the registration/deletion processing of a file to which a recall control is to be executed for the recall inhibiting list 1009. The recall inhibiting list 1009 is a list that is referred to for judging whether or not a file to which a recall is to be executed is also a file to which a recall inhibition is to be executed in the case in which the recall control program 1007 executes a recall processing.

The entry of the recall inhibiting list 1009 is composed of a file (path) name of a file to which a recall inhibition is to be executed and a client name of a client that requests a recall inhibition control. For instance, an entry 510 indicates that a client 1 inhibits a recall of /home/user1/aaa.txt, and an entry 520 indicates that a client 3 inhibits a recall of /tmp/bbb.doc. By using a wild card, it can be set to inhibit a recall of a plurality of files at one time. For instance, in the case in which a file (path) name of a file to which a recall inhibition is to be executed is specified to be “/tmp/*” when the application 3001 starts an inhibition of a recall, a recall of all files that exist under the /tmp directory is inhibited.

In the case in which a message of a command directs a start of a recall inhibition, the file-sharing server program 1003 that has received the command of a recall inhibition control processing makes a set of a file name of a file to which an inhibition is to be executed and a client name of a client that has transmitted the message, and registers the name set to the recall inhibiting list 1009. For instance, in the case in which the client 1 directs a start of a recall inhibition of /home/user1/aaa.txt, the entry 510 is added to the recall inhibiting list 1009.

In the case in which a command of a recall inhibition control processing directs a release of a recall inhibition of a file, the file-sharing server program 1003 deletes the corresponding entry from the recall inhibiting list. For instance, in the case in which the client 1 directs a release of a recall inhibition of /home/user1/aaa.txt, the entry 510 is deleted from the recall inhibiting list 1009.

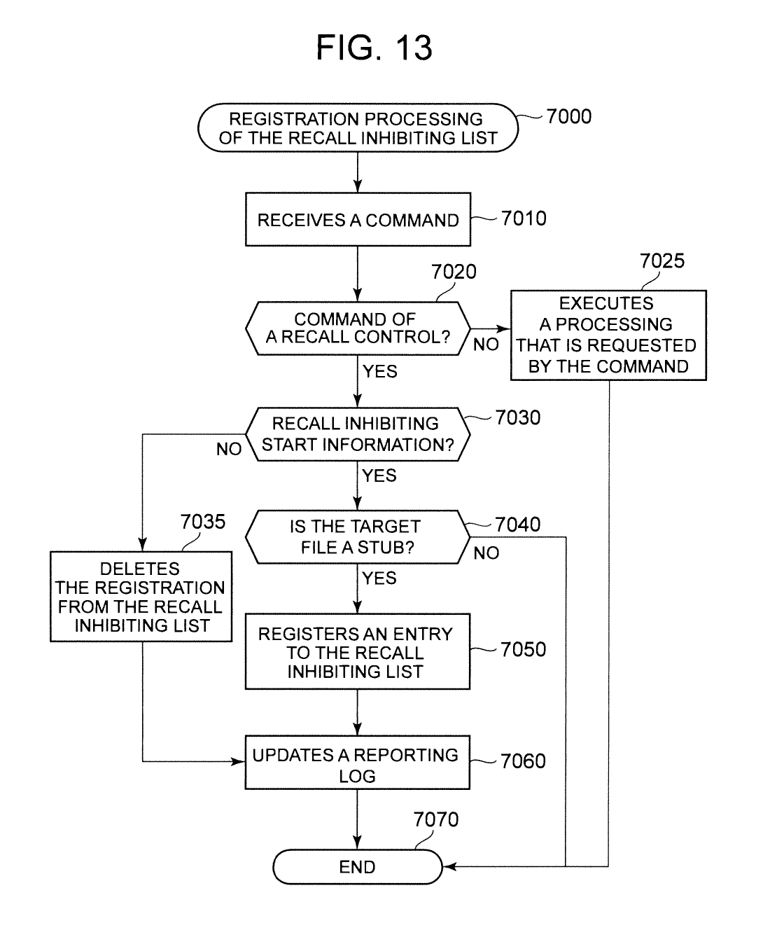

FIG. 13 is a flowchart showing a processing in which the file-sharing server program 1003 registers a file to which a recall control is to be executed to the recall inhibiting list 1009. The flowchart is started at a timing in which the file-sharing server program 1003 receives a command from the file-sharing program 3003.

In a step 7010, the file-sharing server program 1003 receives a command from the file-sharing client program 3003.

In a step 7020, the file-sharing server program 1003 judges whether the received command is a command for a recall control processing or a command for a normal file operation (such as the read/write, the creation/deletion, and the modification/confirmation of an attribute).

In the case in which the command that has been received by the file-sharing server program 1003 is not a command for a recall control processing (step 7020: NO), a processing that is requested by the command is executed, and a registration processing to the recall inhibiting list 1009 is terminated.

In the case in which the command that has been received by the file-sharing server program 1003 is a command for a recall control processing (step 7020: YES), the file-sharing server program 1003 judges whether or not the command for a recall control processing is a command that informs of a start of a recall inhibition (step 7030).

In the step 7030, in the case in which the command for a recall control processing is not a command that informs of a start of a recall inhibition (step 7030: NO), the file-sharing server program 1003 retrieves a file to which a recall control is to be executed and an entry of a client name of a client that has transmitted the command for a recall control processing, and deletes the entry from the recall inhibiting list 1009 (step 7035). The file-sharing server program 1003 then records that a recall inhibition of the file has been released into the reporting log 1010 (step 7060), and the registration processing to the recall inhibiting list 1009 is terminated.

In the step 7030, in the case in which the command for a recall control processing is a command that informs of a start of a recall inhibition (step 7030: YES), the file-sharing server program 1003 judges whether or not a file to which a recall inhibition is to be executed is a stub (step 7040).

In the step 7040, in the case in which a file to which a recall inhibition is to be executed is not a stub (step 7040: NO), the file-sharing server program 1003 terminates the registration processing to the recall inhibiting list 1009.

In the step 7040, in the case in which a file to which a recall inhibition is to be executed is a stub (step 7040: YES), the file-sharing server program 1003 adds an entry to the recall inhibiting list 1009 (step 7050). The file-sharing server program 1003 then records that a recall inhibition of the file has been started into the reporting log 1010 (step 7060), and the registration processing to the recall inhibiting list 1009 is terminated.

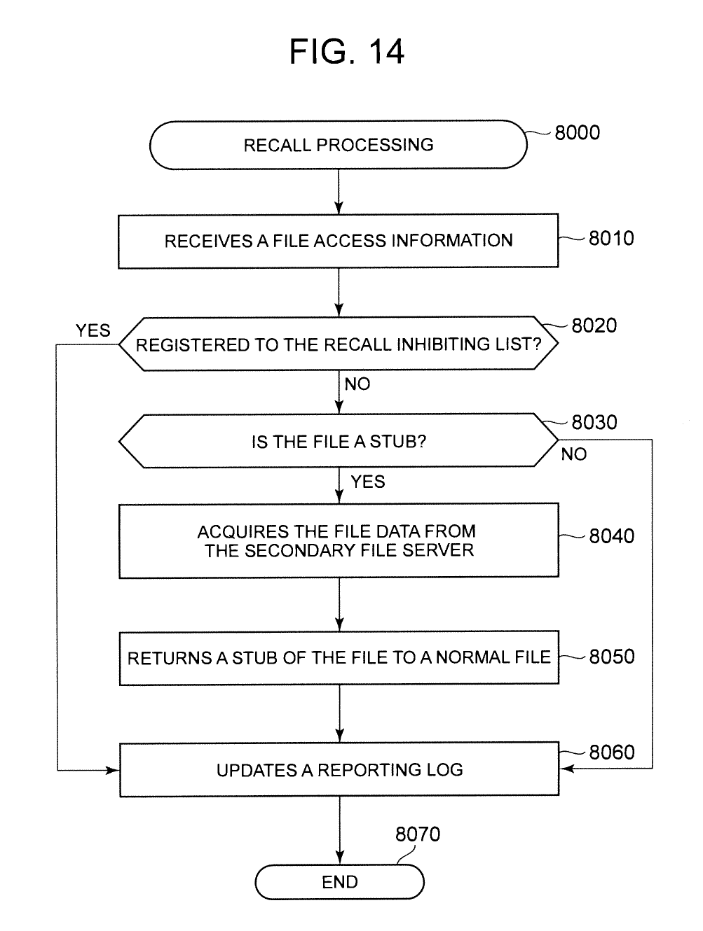

FIG. 14 is a flowchart showing a recall processing that is executed by a recall control program 1007.

As described above, the recall control program 1007 controls a recall processing of a file. A procedure/method in which the recall control program 1007 executes a recall processing will be described in the following.

In the case in which a client computer 300 access a file, the file-sharing server program 1003 informs the recall control program 1007 of a file (path) name of the file and a client name of a client that has requested the access. In the mode of the present invention, in the case in which the file-sharing server program 1003 requests an open of a file to the file system program 1011, the file-sharing server program 1003 informs the recall control program 1007. A timing of the information can also be when the file-sharing server program 1003 requests a read/write of a file to the file system program.

The recall control program 1007 that has received the information checks whether a file name of the file and a client name of the client are registered in an entry of the recall inhibiting list 1009 or not. In the case in which a file name of the file and a client name of the client are not registered in an entry, the recall control program 1007 recalls a file from the secondary file server 200 by using the file-sharing server program 1003. In the case in which a file name of the file and a client name of the client are registered in an entry, a recall of a file is not executed.

A flowchart of a recall processing will be described in the following.

In a step 8010, the recall control program 1007 receives the information of a file access from the file-sharing server program 1003. The information includes a client name of the client that has accessed the file a file name of a file that is to be accessed.

In the step 8020, the recall control program 1007 checks the recall inhibiting list 1009, and confirms whether or not a file that is to be accessed and a client that has requested the access are registered in an entry of the recall inhibiting list 1009.

In the case in which a file that is to be accessed and a client that has requested the access are registered in the recall inhibiting list 1009 (step 8020: YES), that the file has been accessed is recorded into the reporting log 1010 (step 8060), and a recall processing is terminated.

In the case in which a file that is to be accessed and a client that has requested the access are not registered in the recall inhibiting list 1009 (step 8020: NO), it is judged whether or not the file is a stub (step 8030).

In the case in which the file is not a stub (step 8030: NO), that the file has been accessed is recorded into the reporting log 1010 (step 8060), and a recall processing is terminated.

In the case in which the file is a stub (step 8030: YES), the recall control program 1007 acquires the data of the file that is corresponded to the stub from the secondary file server 200 (step 8040), and returns the stub of the file to a normal file (more specifically, by using the file system program 1011, a value of the is_stub entry is set to 0, and the data of the file that has been acquired from the secondary file server 200 is written to a block that is indicated by the block_number entry) (step 8050). That the file has been accessed is then recorded into the reporting log 1010 (step 8060), and a recall processing is terminated.

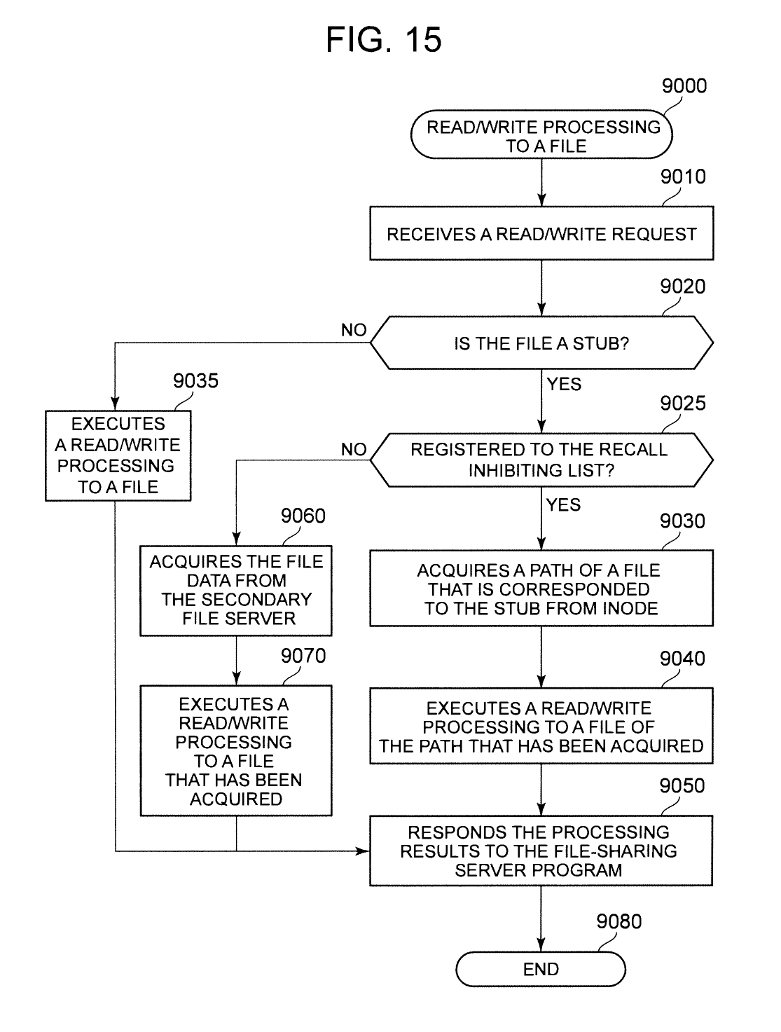

FIG. 15 is a flowchart showing the case in which the file system program 1011 processes a read/write request to a file.

In a step 9010, the file system program 1011 receives a read/write request from the file-sharing server program 1003.

In a step 9020, the file system program judges whether or not a file to which the read/write has been requested is a stub.

In the case in which the file is not a stub (step 9020: NO), the file system program 1011 executes the read/write processing to the file (step 9035), and returns the result of the processing to the file-sharing server program 1003 (step 9050).

In the case in which the file is a stub (step 9020: YES), the file system program 1011 judges whether or not the stub is registered in the recall inhibiting list.

In the case in which the stub is registered in the recall inhibiting list (step 9025: YES), the file system program 1011 acquires a path on the secondary file server 200 that has stored a file that is corresponded to the stub from a block that is indicated by the block_number entry of inode (step 9030). The read/write processing to the file of the path is then executed by the file-sharing client program 1002 (step 9040). The read/write processing to the file that has been stored into the secondary file server 200 is executed as described in the following. The file system program 1011 executes the read/write processing to the file. For instance, in the case in which a file that is corresponded to /home/user1/aaa.txt that has become a stub has been stored into /export/archive/home/user1/aaa.txt of the secondary file server 200, the file system program 1011 executes the read/write processing to /export/archive/home/user1/aaa.txt by using the file-sharing client program 1002. The file system program 1011 then returns the result of the processing to the file-sharing server program 1003 (step 9050). After that, the file-sharing server program 1003 responds the result of the processing to the client computer 300. In this case, in the case in which a transmission from the secondary file server 200 to the client computer is executed, the file is stored into the memory 102 of the primary file server 100, and the file is responded to the client computer 300. By the above configuration, a file to which a recall is inhibited can be returned to the client computer 300 without storing the file into the primary file server 100.

In the case in which the stub is not registered in the recall inhibiting list (step 9025: NO), a file that has been stored into the secondary file server 200 is recalled to the primary file server 100 (step 9060). The recall processing is similar to a processing that has been described in FIG. 14. The read/write processing is then executed to the recalled file (step 9070). After that, the file is responded to the client computer 300.

The reporting program 1008 processes the information that has been stored into the reporting log 1010 to be the reporting information, and presents the information to an administrator. The administrator can know the access pattern to the file and can confirm whether or not the application executes a recall inhibition of a file as expected from the reporting information.

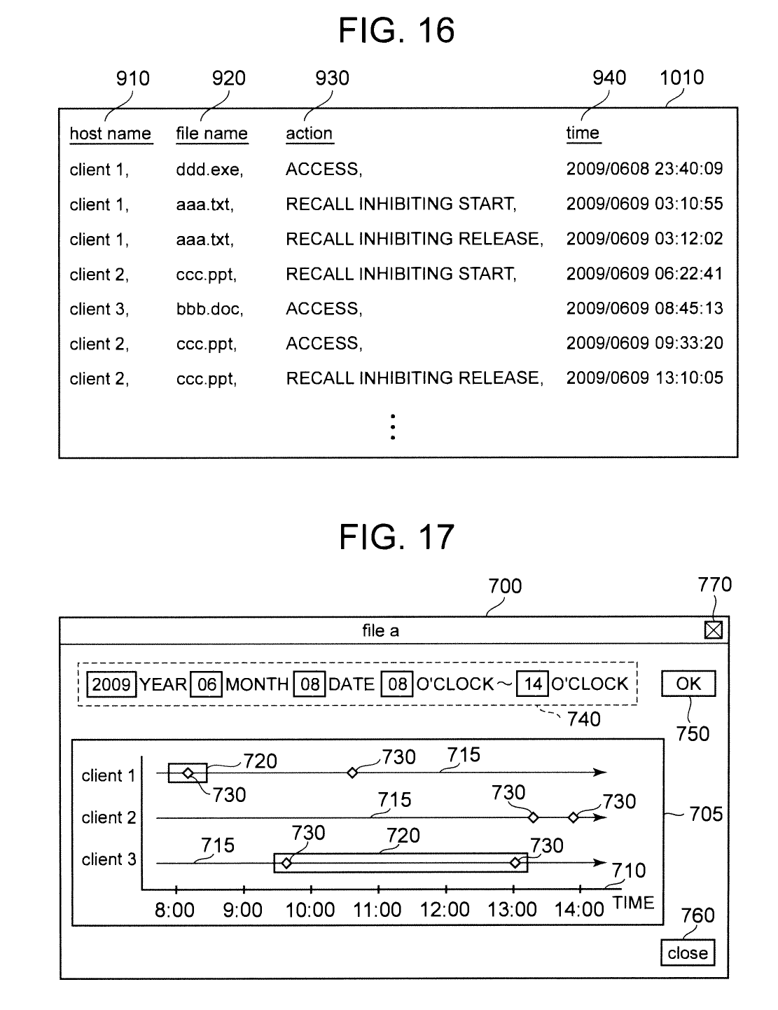

FIG. 16 is a view showing a format of the reporting log 1010.

An “action” (column 930) records an operation that has been executed by a client. In the case in which a file has been accessed, “access” is recorded. In the case of a recall inhibiting start processing to a file, “recall inhibiting start” is recorded. In the case of a recall inhibiting release processing to a file, “recall inhibiting release” is recorded. A “host name” (column 910) stores a client name of a client that has executed an operation. A “file name” (column 920) stores a file name of a file to be operated. A “time” (column 940) stores time when an operation is executed. The reporting log 1010 is updated by the file-sharing server program 1003 and the recall control program 1007 at a timing of the step 7060 of FIG. 13 and the step 8060 of FIG. 14.

FIG. 17 is an example of the reporting information that is presented to an administrator of the primary file server 100 by the reporting program 1008.

The reporting program 1008 analyzes the reporting log 1010, and presents a graph 705 to an administrator of the primary file server 100. The graph 705 is prepared for a file that has been stored into the storage device 103.

A horizontal axis of the graph indicates the passage of time. A time chart 715 is prepared for every client, and time when a client executed each operation can be confirmed. The time indicated in the graph can be specified in a time entry field 740. In the case in which an OK button 750 is pressed, a graph of time that has been entered into the time entry field is displayed. A closed section 720 is a period in which a client inhibits a recall of a file, that is, a period from a start of an inhibition of a recall to an end of an inhibition of a recall. A point 730 indicates time when a client accessed a file. A time chart is displayed for every client as shown in the figure. A window 700 that displays the graph can be closed by pressing a close button 760 or a button 770 with a click.

The graph is displayed on a management computer (not shown in FIG. 2) that is coupled to the LAN 400 or a display output device (not shown in FIG. 2) of the primary file server 100.

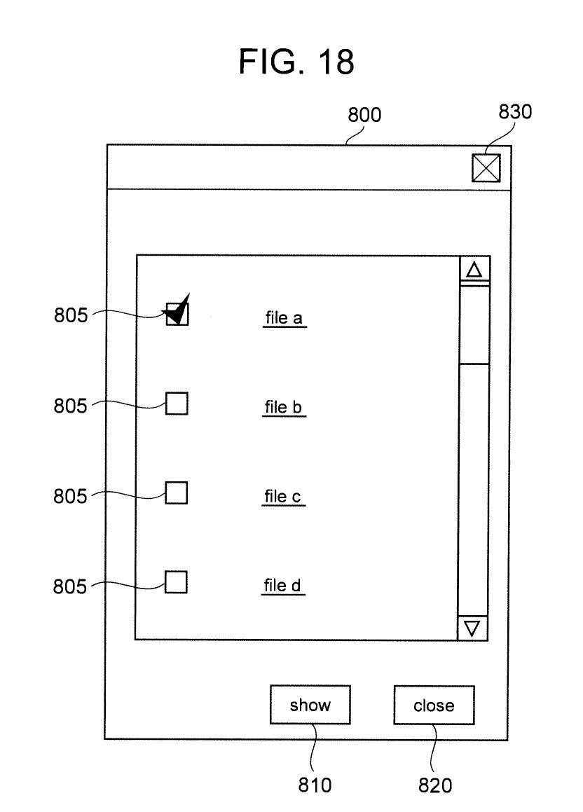

FIG. 18 is an example of a GUI window for selecting a file that displays the graph.

A file that displays a graph can be selected from a window 800. A check box 805 of a file for displaying a graph is checked, and a show button 810 is pressed, thereby displaying the graph as shown in FIG. 17. The window 800 can be closed by pressing a close button 820 or a button 830.

An administrator of the primary file server 100 can monitor a behavior of an application that is coupled to the primary file server 100 by confirming a time chart shown in FIG. 17. For instance, in the case in which there are several accesses to a file from the same client in an inhibition period of a recall, it is judged that the application does not execute an expected operation.

The reporting program 1008 can execute a release of a recall inhibition based on the reporting information. The reporting program 1008 periodically analyzes the reporting log 1010. In the case in which a client computer 300 accesses a file at least a certain number of times when the client inhibits a recall of the file, it is suitable that the file is recalled to the primary storage 100. In this case, it is judged that the application 3001 does not control a recall in an appropriate manner, and the entries of the file and the client are deleted from the recall inhibiting list 1009. The file is then recalled from the secondary file server 200 to the primary file server 100. In the case in which the number of accesses from the client computer 300 to a file to which a recall is inhibited becomes a certain number of times or more, a recall inhibition can be released. Moreover, an administrator can also forcibly release a recall inhibition.

In the case in which a plurality of applications 3001 are operated on one client computer 300, even if one application 3001 executes a recall inhibition of a file, a recall inhibition can be released when there is an access from other application 3001 to the file.

By the above configuration, even for a file to which a recall is inhibited, the file that is accessed again is recalled, thereby enabling an appropriate recall control.

In the first embodiment, a creation/deletion processing of “<file_name>.norc” (<file_name> is a file (path) name of a file to which a recall is inhibited) was mentioned as a processing for controlling a recall. However, other specific processing can also be a recall control processing. Another embodiment will be described in the following.

In the second embodiment, an addition/deletion processing of an ACE (Access Control Entry) to an ACL (Access Control List) is set as a recall control processing.

The ACL is a list for managing an access permission of each user to a file, and is provided with the ACE as an entry. In the ACE, an access permission of each user to a file is defined. A server can manage an access permission of each user to a file. A protocol of an NFS and a CIFS supports an addition of the ACE from a remote server.

In the second embodiment, an addition/deletion processing for the ACE to a user of specific uid is a start/end processing of a recall inhibition. The uid is an id that is uniquely assigned to a user that utilizes a server. A server identifies a user by the uid. A fixed value can be used for the specific uid that is used here, or an administrator of the primary file server 100 can set the specific uid. However, uid of a user that does not exist in a practical sense in the primary file server 100 that is coupled is used. Here, uid is 1000 tentatively for an explanation.

In the case in which it is required that a recall inhibition of a file is started, the application 3001 creates an ACE to uid=1000 and adds the ACE to the ACL of the file. The content of an access permission that is registered to the ACE is not restricted in particular. For instance, in the case in which it is required that a recall inhibition of a file of /tmp/bbb.doc is started, the application 3001 creates an ACE to uid=1000 and requests a processing that is added to the ACL of /tmp/bbb.doc to the file system program 3002. The file system program 3002 then requests a creation of a command to the file-sharing client program 3003. The file-sharing client program 3003 creates a command for requesting an addition of the ACE, and transmits the command to the file-sharing server program 1003. The file-sharing server program 1003 that has received the command for requesting an addition of the ACE judges that the command is a message that informs of a recall inhibition start of /tmp/bbb.doc, and executes a registration processing to the recall inhibiting list 1009. The file-sharing server does not execute a registration to the ACL in a practical sense.

In the case in which it is required that a recall inhibition of a file is released, the application 3001 requests a processing for deleting an ACE to uid=1000 to the file system program 3002.

For instance, in the case in which it is required that a recall inhibition of a file of /tmp/bbb.doc is released, the application 3001 requests a processing for deleting an ACE to uid=1000 from the ACL of /tmp/bbb.doc to the file system program 3002. The file system program 3002 then requests a creation of a command to the file-sharing client program 3003. The file-sharing client program 3003 creates a command for requesting a deletion of the ACE, and transmits the command to the file-sharing server program 1003. The file-sharing server program 1003 that has received the command for requesting a deletion of the ACE judges that the command is a message that informs of a recall inhibition release of /tmp/bbb.doc, and executes a deletion processing to the recall inhibiting list 1009.

In the third embodiment, a processing for changing atime of a file is set as a recall control processing. A command for changing atime from a current time to time one year later is the start information of a recall inhibition, and a command for changing atime from a current time to time one year ago is the release information of a recall inhibition.

In the case in which it is required that a recall inhibition of a file is started, the application 3001 executes a processing for changing atime from a current time to time one year later. For instance, in the case in which it is required that a recall inhibition of a file of /tmp/bbb.doc is started, the application 3001 requests a processing for changing atime of /tmp/bbb.doc from a current time to time one year later to the file system program 3002. The file system program 3002 then requests a creation of a command to the file-sharing client program 3003. The file-sharing client program 3003 creates a command for changing atime of /tmp/bbb.doc from a current time to time one year later, and transmits the command to the file-sharing server program 1003. The file-sharing server program 1003 that has received the command for changing atime from a current time to time one year later judges that the command is a message that informs of a recall inhibition start of /tmp/bbb.doc, and executes a registration processing to the recall inhibiting list 1009. The file-sharing server does not execute a change of atime in a practical sense.

In the case in which it is required that a recall inhibition of a file is released, the application 3001 executes a processing for changing atime from a current time to time one year ago For instance, in the case in which it is required that a recall inhibition of a file of /tmp/bbb.doc is released, the application 3001 requests a processing for changing atime of /tmp/bbb.doc from a current time to time one year ago to the file system program 3002. The file system program 3002 then requests a creation of a command to the file-sharing client program 3003. The file-sharing client program 3003 creates a command for changing atime of /tmp/bbb.doc from a current time to time one year ago, and transmits the command to the file-sharing server program 1003. The file-sharing server program 1003 that has received the command for changing atime from a current time to time one year ago judges that the command is a message that informs of a recall inhibition release of /tmp/bbb.doc, and executes a deletion processing to the recall inhibiting list 1009.

In the above embodiments, the NFS and CIFS programs are assumed as a file-sharing program of the client computer 300 and the primary server 100. However, the application 3001 can also execute a recall control processing to a file on the primary file server 100 by using a protocol of other file-sharing programs.

In a mode in accordance with the present invention described above, a hierarchical storage is built by using two file servers. However, the storage devices that have different features can also be disposed together in one file server. For instance, the present invention can also be applied to a hierarchical storage in which an SSD and a tape device are disposed in one file server to migrate a file that has less access times from the SSD to the tape device.

In addition, in a mode in accordance with the present invention described above, two storage systems are disposed for building a hierarchical storage. However, the present invention can also be applied to a hierarchical storage in which more than two storage systems are used.

As described above, by the mode in accordance with the present invention, in the case in which the application 3001 on the client 300 accesses a file on the secondary file server 200, a recall of a file to which an access is to be executed can be inhibited, and the file can be prevented from being recalled to the primary file server 100.

For instance, in the case in which the application 3001 is the antivirus software and a scan of all files on the primary file server 100 is executed. A great amount of files can be prevented from being recalled by inhibiting a recall of a file to which a scan is to be executed in advance. Moreover, in the case in which a file in which a recall is inhibited is accessed at least a certain number of times, a recall is executed. Consequently, a file can be disposed in a more appropriate manner.

As described above, by utilizing the present invention, a capacity of a primary storage in a hierarchical storage can be used in an efficient manner, and an unnecessary copy of a file can be reduced advantageously.

What is claimed is:

1. A hierarchical storage system comprising:
a client computer;
a first storage apparatus that is coupled to the client computer and that is provided with a first storage area; and
a second storage apparatus that is coupled to the first storage apparatus and that is provided with a second storage area,
wherein the first storage apparatus stores a file and a stub file that is provided with the information that indicates the stored location of a file that has been migrated from the first storage area and has been stored into the second storage area into the first storage area,
wherein the first storage apparatus receives a direction that inhibits a copy of a file that is corresponded to the stub file into the first storage area from the client computer, and
wherein, in the case in which the first storage apparatus receives an access request to the stub file that has received the copy inhibiting direction from the client computer, the first storage apparatus processes the access request to the file that is corresponded to the stub file and that has been stored into the second storage area and responds to the client computer.

2. The hierarchical storage system according to claim 1, wherein:
the first storage apparatus is provided with a memory,
the first storage apparatus judges whether a target of the access request from the client computer is the file or the stub file,
in the case in which the first storage apparatus receives an access request to the stub file that has received the copy inhibiting direction from the client computer, the first storage apparatus processes the access request to the file that is corresponded to the stub file and that has been stored into the second storage area, stores the file that is a target of the access request into the memory, and responds to the client computer,
in the case in which the first storage apparatus receives an access request to the stub file that has not received the copy inhibiting direction from the client computer, the first storage apparatus copies the file that is corresponded to the stub file and that has been stored into the second storage area to the first storage area, processes the access request to the file that has been copied, and responds to the client computer, and
in the case in which the first storage apparatus receives an access request to the file that has been stored into the first storage area from the client computer, the first storage apparatus processes the access request to the file that has been stored into the first storage area, and responds to the client computer.

3. The hierarchical storage system according to claim 2, wherein:
in the case in which the number of times of access requests to the stub file that has received the copy inhibiting direction from the client device is at least a certain number of times, the first storage apparatus copies the file that is corresponded to the stub file and that has been stored into the second storage area to the first storage area.

4. The hierarchical storage system according to claim 3, wherein:
in the case in which the first storage apparatus receives a direction that releases the copy inhibition from the client computer and receives an access request to the stub file from the client computer, the first storage apparatus copies the file that is corresponded to the stub file and that has been stored into the second storage area to the first storage area, and responds to the client computer.

5. The hierarchical storage system according to claim 4, wherein the first storage apparatus records the date and time of the copy inhibiting direction, the date and time of the copy inhibiting release, and the date and time of an access from the client device to the file or the stub file for every file or stub file.

6. The hierarchical storage system according to claim 5, wherein:
the first storage apparatus is provided with a screen display device, and the screen display device displays the date and time of the copy inhibiting direction, the date and time of the copy inhibiting release, and the date and time of an access from the client device to the file or the stub file for every file or stub file.

7. The hierarchical storage system according to claim 6, wherein:
the first storage area is a storage apparatus that has a small capacity and that accesses at a high speed, and
the second storage area is a storage apparatus that has a large capacity and that accesses at a low speed.

8. A copy control method of a file for a hierarchical storage system comprising:
a client computer;
a first storage apparatus that is coupled to the client computer and that is provided with a first storage area; and
a second storage apparatus that is coupled to the first storage apparatus and that is provided with a second storage area,
wherein the first storage apparatus stores a file and a stub file that is provided with the information that indicates the stored location of a file that has been migrated from the first storage area and has been stored into the second storage area into the first storage area,
the first storage apparatus receives a direction that inhibits a copy of a file that is corresponded to the stub file into the first storage area from the client computer, and
in the case in which the first storage apparatus receives an access request to the stub file that has received the copy inhibiting direction from the client computer, the first storage apparatus processes the access request to the file that is corresponded to the stub file and that has been stored into the second storage area and responds to the client computer.

9. The copy control method of a file for a hierarchical storage system according to claim 8, wherein:
the first storage apparatus is provided with a memory,
the first storage apparatus judges whether a target of the access request from the client computer is the file or the stub file,
in the case in which the first storage apparatus receives an access request to the stub file that has received the copy inhibiting direction from the client computer, the first storage apparatus processes the access request to the file that is corresponded to the stub file and that has been stored into the second storage area, stores the file that is a target of the access request into the memory, and responds to the client computer,
in the case in which the first storage apparatus receives an access request to the stub file that has not received the copy inhibiting direction from the client computer, the first storage apparatus copies the file that is corresponded to the stub file and that has been stored into the second storage area to the first storage area, processes the access request to the file that has been copied, and responds to the client computer, and
in the case in which the first storage apparatus receives an access request to the file that has been stored into the first storage area from the client computer, the first storage apparatus processes the access request to the file that has been stored into the first storage area, and responds to the client computer.

10. The copy control method of a file for a hierarchical storage system according to claim 9, wherein:
in the case in which the number of times of access requests to the stub file that has received the copy inhibiting direction from the client device is at least a certain number of times, the first storage apparatus copies the file that is corresponded to the stub file and that has been stored into the second storage area to the first storage area.

11. The copy control method of a file for a hierarchical storage system according to claim 10, wherein:
in the case in which the first storage apparatus receives a direction that releases the copy inhibition from the client computer and receives an access request to the stub file from the client computer, the first storage apparatus copies the file that is corresponded to the stub file and that has been stored into the second storage area to the first storage area, and responds to the client computer.

12. The copy control method of a file for a hierarchical storage system according to claim 11, wherein the first storage apparatus records the date and time of the copy inhibiting direction, the date and time of the copy inhibiting release, and the date and time of an access from the client device to the file or the stub file for every file or stub file.

13. The copy control method of a file for a hierarchical storage system according to claim 12, wherein:
the first storage apparatus is provided with a screen display device, and
the screen display device displays the date and time of the copy inhibiting direction, the date and time of the copy inhibiting release, and the date and time of an access from the client device to the file or the stub file for every file or stub file.

14. The hierarchical storage system according to claim 13, wherein:
the first storage area is a storage apparatus that has a small capacity and that accesses at a high speed, and
the second storage area is a storage apparatus that has a large capacity and that accesses at a low speed.

15. A hierarchical storage system comprising:
a client computer;
a first storage apparatus that is coupled to the client computer and that is provided with a first storage are and a memory; and
a second storage apparatus that is coupled to the first storage apparatus and that is provided with a second storage area,
wherein the first storage area has a small capacity and accesses at a high speed,
the second storage area has a large capacity and accesses at a low speed,
the first storage apparatus stores a file and a stub file that is provided with the information that indicates the stored location of a file that has been migrated from the first storage area and has been stored into the second storage area into the first storage area,
the first storage apparatus judges whether a target of the access request from the client computer is the file or the stub file,
the first storage apparatus receives a direction that inhibits a copy of a file that is corresponded to the stub file into the first storage area from the client computer,
in the case in which the first storage apparatus receives an access request to the stub file that has received the copy inhibiting direction from the client computer, the first storage apparatus processes the access request to the file that is corresponded to the stub file and that has been stored into the second storage area, stores the file that is a target of the access request into the memory, and responds to the client computer,
in the case in which the first storage apparatus receives an access request to the stub file that has not received the copy inhibiting direction from the client computer, the first storage apparatus copies the file that is corresponded to the stub file and that has been stored into the second storage area to the first storage area, processes the access request to the file that has been copied, and responds to the client computer,
in the case in which the first storage apparatus receives an access request to the file that has been stored into the first storage area from the client computer, the first storage apparatus processes the access request to the file that has been stored into the first storage area, and responds to the client computer, and
in the case in which the number of times of access requests to the stub file that has received the copy inhibiting direction from the client device is at least a certain number of times, the first storage apparatus copies the file that is corresponded to the stub file and that has been stored into the second storage area to the first storage area.
